(19) United States
(12) Patent Application Publication
(10) Pub. No.: US 2020/0041245 A1
(43) Pub. Date: Feb. 6, 2020

(54) AQUARIUM RULER

(71) Applicant: Troy Davis, Baltimore (US)

(72) Inventor: Troy Davis, Baltimore (US)

(21) Appl. No.: 16/051,474

(22) Filed: Jul. 31, 2018

(51) Int. Cl. G01B 3/04; F16B 47/00

(52) U.S. Cl. CPC G01B 3/04; A01K 61/95; F16B 47/00

(57) ABSTRACT

The Aquarium Ruler is a transparent polyvinyl aquarium fish ruler used for the measurement of ornamental aquarium inhabitants by hobbyist, enthusiast, and breeders. The aquarium fish ruler attaches to aquarium glass and acrylic surfaces. The construction of the aquarium ruler is composed of a twelve-inch ruler with mushroom head suction cups inserted into the back side of the aquarium ruler through two key holes. The front of the aquarium ruler is adorned with the product name, length indicia, aquatic inhabitants common to the ornamental fish hobby, and two small sized key holes for the insertion of the mushroom head suction cups.

### BACKGROUND OF THE INVENTION

### 1. FIELD OF THE INVENTION

The present invention relates generally to the ornamental aquatic hobby and more particularly to the improved measurement of ornamental aquatic inhabitants housed in glass or acrylic aquariums.

### 2. DESCRIPTION OF RELATED ART

The present invention relates generally to the ornamental aquatic hobby and more particularly to the improved measurement of ornamental aquatic inhabitants housed in glass or acrylic aquariums. Many fish and aquatic breeders, hobbyist, and enthusiast have created many ingenious ways to determine the length of aquarium housed fish and inhabitants, prior to sale or for general knowledge for self. The most common way of determining the length of a fish or aquatic inhabitant is by placing an object with a known length next to the aquarium or by taping an object with a known length onto the aquarium. These methods have proven to provide an inaccurate measurement of the fish and are found to be not aesthetically pleasing. Previous inventions have been deemed and proven to be overly complicated to achieve this simple task.

A large percentage of hobbyists physically remove fish from the aquarium to measure the fish's length with a measuring apparatus. Each time a fish is removed from the water and touches a fish net or the hands of the handler, their slime coat is compromised. The slime coat of a fish functions as a protective coating to the fish's scales. The slime coat acts as the first line of defense against parasitic infections, bacteria, and other diseases that a fish may contract. Once the slime coat has been compromised or deteriorated, the fish is very susceptible to bacterial, parasitic and viral infections.

The invention of this aquarium ruler will provide a simple but yet accurate and aesthetically pleasing measuring device for the ornamental fish and aquatic hobby. This invention allows the hobbyist to measure fishes without removing them from the aquarium, which does not compromise their slime coat. It will also allow the user to have a safe and aesthetically pleasing option. If the hobbyist prefers to remove the fish for measurement, this aquarium ruler will be readily available as it will be attached to the glass or acrylic of the aquarium with mushroom head suction cups. The aquarium ruler can easily be removed from the mushroom head suction cups by sliding it upwards. The aquarium ruler can be easily reattached to the mushroom head suction cups once measuring of the fish has been completed by placing it back onto the mushroom head suction cups and sliding it downwards.

Currently, the United States ornamental fish hobby does not have a dedicated measuring device used to measure fishes length or growth. Previous measuring devices have been found to be inaccurate, too complicated, and not customer friendly. This measuring device encompasses mushroom head suction cups and key holes, which simplifies and separates this aquarium ruler from attempted designs.

### BRIEF SUMMARY OF THE INVENTION

The present invention provides an aquarium fish or aquatic inhabitant measuring ruler that allows the hobbyist, breeder or enthusiast to measure their aquarium inhabitants without removing them from the aquarium. The aquarium ruler incorporates two mushroom head suction cups that are inserted into the back of two key holes that are on the aquarium fish ruler. Once inserted, the mushroom head suction cups are then pushed upward to lock or secure them into the aquarium ruler. Inserting the two mushroom head suction cups into the aquarium ruler allows the suction cups to remain stationary while attached to the aquarium ruler. The two mushroom head suction cups allow the aquarium ruler to be attached to glass or acrylic aquariums in a stationary position. The stationary aquarium ruler can simply be removed from the suction cups by lifting the ruler from both ends in an upwards motion until it releases from the mushroom head suction cups. The aquarium ruler and mushroom head suction cups are made of transparent polyvinyl that allows the hobbyist to view and measure the fish or aquatic inhabitants as they are in a stationary position or swimming by the location in which the aquarium ruler is attached to the aquarium.

The top front of the aquarium ruler has length indicia in standardized measurement represented by a centimeter measuring scale. The bottom front of the aquarium ruler has length indicia in standardized measurements represented by the inch measuring scale. The front of the aquarium fish ruler is adorned with common aquatic inhabitants of the ornamental hobby. The name of the invention will be located in the center of the aquarium ruler.

### BRIEF DESCRIPTION OF THE DRAWINGS

The invention will be better understood and objects that are set forth above will become apparent when consideration is given to the following detailed description thereof. Such description makes reference to the annexed drawings, wherein:

FIG. 1 is a front view of the aquarium ruler illustrating the the aquarium ruler without the mushroom head suction cups inserted into the aquarium ruler;

FIG. 2 is a front view of the aquarium ruler illustrating the aquarium ruler with the mushroom head suction cups inserted into the aquarium ruler; FIG. 2 encompasses an exploded view of a front view of two ruler components;

FIG. 3 is a right-side view of the aquarium ruler illustrating the aquarium ruler with the mushroom head suction cups attached to the aquarium ruler; FIG. 2 encompasses an exploded view of a side view of one ruler component;

### DETAILED DESCRIPTION OF THE INVENTION

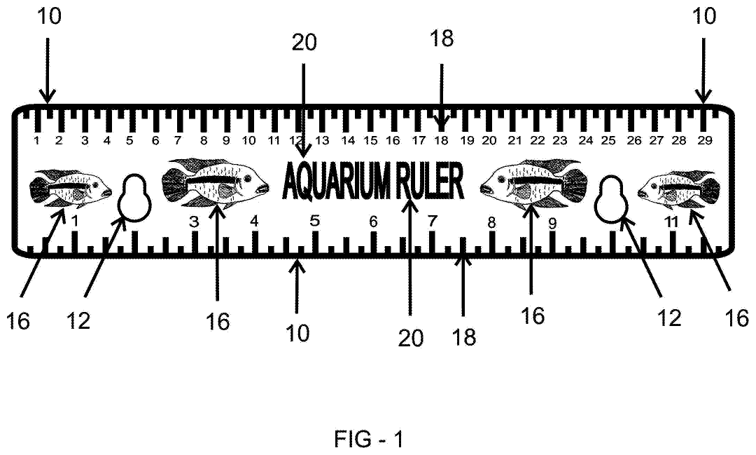

1. Referring to FIG. 1 through FIG. 3, wherein the like reference numerals refer to the like components in the various views, there is illustrated therein a aquarium ruler specifically for the purpose of measuring ornamental aquatic inhabitants with a standardized measuring scale, solely denominated 10 herein.

FIG. 1 is a front view of an aquarium ruler 10 of this invention, illustrating two key holes 12 in the ruler. Aquatic inhabitants 16 common to the ornamental fish hobby adorn the face of the aquarium aquarium ruler 10. Length indicia 18 in standardized measurements adorn the top front and bottom front portion of the aquarium ruler 10. The product name 20 is located in the middle of the aquarium ruler.

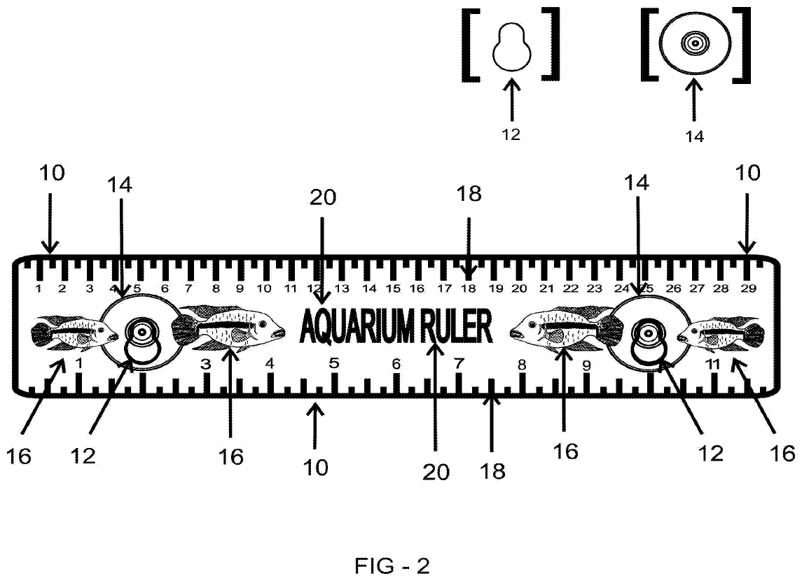

FIG. 2 is a front view of an aquarium ruler 10 of this invention, illustrating two key holes 12 in the ruler. Two mushroom head suction cups 14 are inserted into the rear of the two key holes 12 of the aquarium ruler 10. Aquatic inhabitants 16 common to the ornamental fish hobby adorn the face of the aquarium ruler 10. Length indicia 18 in standardized measurements adorn the top front and bottom front portion of the aquarium ruler 10. The product name 20 is located in the middle of the aquarium ruler. An exploded view displays a front view of the key hole 12. An exploded view displays a front view of mushroom head suction cup 14.

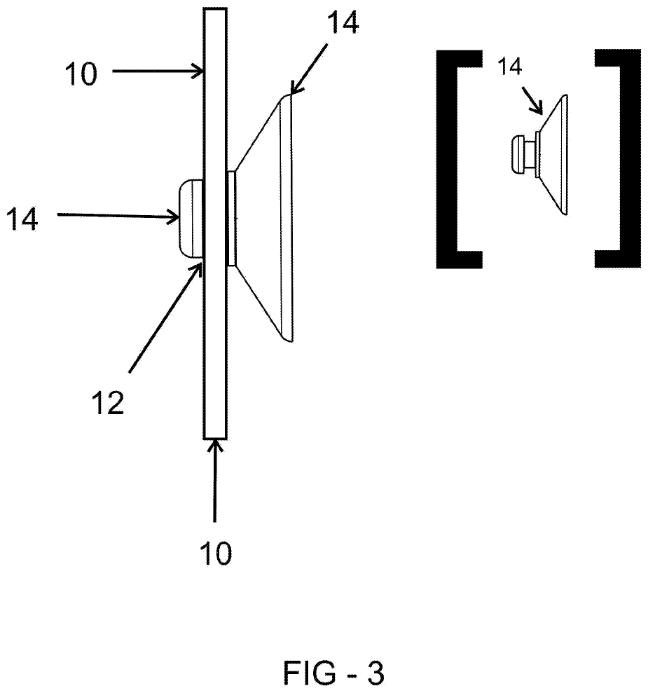

FIG. 3 is a right-side view of the aquarium ruler 10 with mushroom head suction cup 14 inserted through the back of the key hole 12. An exploded view displays a right-side view of the mushroom head suction cup 14.

To use the aquarium ruler 10, the hobbyist inserts the two mushroom head suction cups 14 into the back of the two key holes 12 and then push the mushroom head suction cups upwards to secure or lock into the aquarium ruler 10. The aquarium ruler 10 then attaches to a preferred location on the glass or acrylic aquarium.

Features of the inventive aquarium ruler may include, but are not limited to, the following: Measures aquatic inhabitants lengths up to 12 inches (30 centimeters)

[symbol]

What is claimed as invention is:

1. An aquarium ruler 10; two key holes 12 in the aquarium ruler; two mushroom head suction cups 14. One key hole 12 is vertically centered at the two inch indicia of the aquarium ruler 10. One key hole 12 is vertically centered at the ten inch indicia of the aquarium ruler 10. One mushroom head suction cup 14, will be inserted into the key hole 12 vertically centered at the two inch indicia of the aquarium ruler 10. One mushroom head suction cup 14, will be inserted into the key hole 12 vertically centered at the ten inch indicia of the aquarium ruler 10.

2. The aquarium ruler 10 of claim 1 is adorned with aquatic inhabitants 16 common to the ornamental fish hobby

3. The aquarium ruler 10 of claim 1 is adorned with length indicia 18 at the top front and bottom front or the aquarium ruler 10.

4. The length indicia 18 of claim 3 at the top front are represented in standardized measurement scale of centimeters.

5. The length indicia 18 of claim 3 at the bottom front are represented in standardized measurement scale of inches.

6. The two mushroom head suction cups 14 of claim 1 that are inserted into the two key holes 12 of the aquarium ruler 10, are attached or mounted to a glass or acrylic aquarium surface.
